(19) United States
(12) Patent Application Publication
(10) Pub. No.: US 2017/0371965 A1
(43) Pub. Date: Dec. 28, 2017

(54) METHOD AND SYSTEM FOR DYNAMICALLY PERSONALIZING PROFILES IN A SOCIAL NETWORK

(71) Applicants: Ali DAVAR, Vancouver (CA); Kazem JAHANBAKHSH, Vancouver (CA); David THOMPSON, Vancouver (CA)

(72) Inventors: Ali DAVAR, Vancouver (CA); Kazem JAHANBAKHSH, Vancouver (CA); David THOMPSON, Vancouver (CA)

(73) Assignee: 0934781 B.C. Ltd, Vancouver (CA)

(21) Appl. No.: 15/633,675

(22) Filed: Jun. 26, 2017

Related U.S. Application Data
(60) Provisional application No. 62/354,009, filed on Jun. 23, 2016.

(51) Int. Cl. G06F 17/30; G06Q 50/00

(52) U.S. Cl. CPC G06F 17/30864; G06Q 50/01

(57) ABSTRACT

A method and system for communicating content associated with organization relevant to a search. The users are determined by matching users that provide a service satisfying a search query. The content is selected based on determining what content is most relevant to the search query

### BACKGROUND

Search engines are commonly used to return results of the best matching items. The search results typically show abbreviated versions of the items being searched. Specialized search engines are used to search for items within a specific field. For example, a search engine may search within a professional social network or a database of companies. The initial results may be a set of simplified cards representing the matching people or companies. A searcher clicks on a result to see a full profile.

Current databases are able to generate prolific data about a given item, such that a searcher is overwhelmed with all the data available for a sought item. This reduces or dilutes the impact of the search results.

The displaying of the profile tends to ignore the search parameters and fails to point out why the search engine thought the item was relevant. Subsequent viewing of the item is also without the original context that made the item seem relevant originally.

For simplicity, most websites comprise static profiles of people or companies so there is limited ability to persuade searchers. Some websites provide personalization based on data objects common to the searcher and searched item but this may not be relevant to the search itself.

### SUMMARY

According to a first aspect of the invention there is provided a computer-implemented method of personalizing webpages. The method comprises: a server receiving, from a client device, a search query regarding vendors; identifying, from a database, vendor data objects representing service providers satisfying the search query; for a given vendor objects; identifying, from the database, content objects connected in the database to that vendor object, representing a past provision of a service matching the search query; calculating a relevance score for each of the selected content objects based on the search query to rank the content objects; dynamically creating a webpage from the given vendor object and some of their ranked content objects; and communicating the webpage to the client device.

The method may comprise comparing the data objects of service providers to the search query to select a set of service providers for which digital representations are created and communicated.

The method may comprise the server detecting from the client devices a user-selection with regard to one or more of the service providers or one or more content and, in response to said user-selection, automatically adjusting the service model for subsequent predictions of relevance of content items.

The method may comprise creating and communicating to the client device a web page comprising one or more of the digital representations.

The method may comprise the server receiving from a user associated with one of the service providers, one or more rules about communicating content items of that service provider.

The method may comprise the server receiving from the client devices a user-request to save one or more of the service providers in association with a user account, and in response to said response, saving the service provider and the search query in association with a user account.

The content items may be one or more of: case studies, text documents, testimonials, sample work, and awards.

The content item data objects may describe a service previously provided by a service provider connected to the content item data objects in a social network.

The method may comprise automatically generating natural language text by aggregating data from the content items or the service providers.

According to a second aspect of the invention there is provided a computer-implemented method comprising: providing a graph database; receiving a search for an organization; identifying an organization satisfying the search; identifying objects connected to the organization in the graph and retrieving attributes of those objects; selecting a plurality of candidate template statements; populating the candidate template statements using attributes of the connected objects; calculate an impact score for each populated statement based on their relevance to the search and count of object used to populate the statements; and displaying populated statement based on the impact score.

Template statements may correspond to a graph pattern for traversing the graph.

The method may comprise removing template statements whose graph pattern overlaps patterns of template statements having a higher impact score.

The impact score of a candidate statement may increase with the number of unique paths satisfying the graph patterns found for a given organization and with the complexity of the graph pattern.

The method may select candidate template statements that define patterns specified by the search.

According to a third aspect of the invention there is provided a computer-implemented method. The method comprises providing a graph database and a set of policies; receiving a search form a user; selecting a vendor that satisfies the search; operating a Multi-Armed Bandit algorithm to select a policy; retrieving objects connected to the vendor; implementing the selected policy to create a personalized profile for the vendor based on the search; communicating the profile to the user as a User Interface with means for user to select the vendor; receiving a user-selection with respect to the vendor via the UI; and updating reward statistics for the selected policy based on the user-selection; wherein each policy comprises an algorithm for selecting one or more of the connected objects to be used in creating the profile.

A policy may further determine an arrangement of the selected objects within the webpage

Objects may be one or more of: organization, project, award, document, image, or NLG template statements.

The selection of the policy further depends on attributes of the user or of the vendor.

One or more of the policies may calculate a topic model for determining topics of the connected objects and of the search.

One or more of the policies may comprise selecting objects based on attributes of the objects that satisfy the search.

One or more of the policies may comprise selecting objects that are part of a class based on the search query.

One or more of the policies may comprise a function for ranking objects based on weighted attributes of the objects.

### BRIEF DESCRIPTION OF THE DRAWINGS

FIG. 1 is an illustration of connections between software agents of servers and client devices.

FIG. 2 is a portion of a social graph relevant to a search for a freelancer.

FIG. 3 is a table of search queries and user actions.

FIG. 4 is an illustration of elements of a services model.

FIG. 5 is a flow diagram for searching for providers and their content items.

FIG. 6 is a flowchart for matching service providers and service requests.

FIG. 7 is a webpage of sample search results.

FIG. 8A is a graph of select patterns.

FIG. 8B is a table of patterns and corresponding statements.

FIG. 9 is a flowchart for selecting output using a multi armed bandit.

FIG. 10 is a block diagram of a computer system.

### DESCRIPTION

The inventors have appreciated that search sessions may be expedited by providing search results that are personalized to show certain elements of the results that are most relevant to the search thus removing or downplaying additional data that are not relevant.

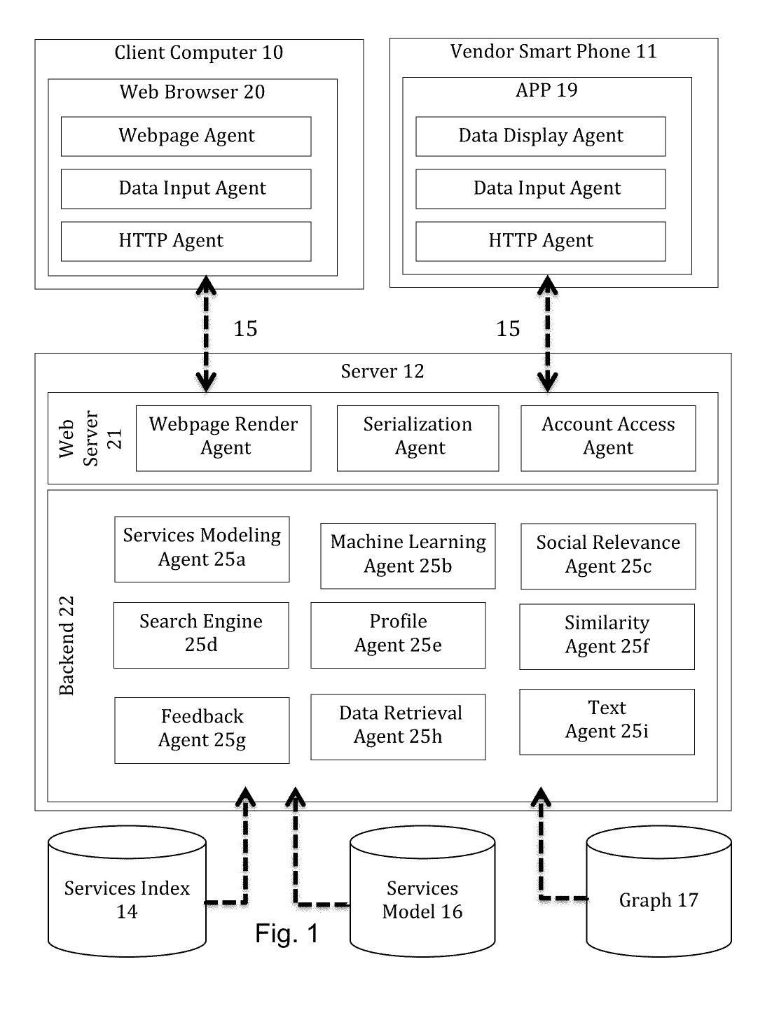

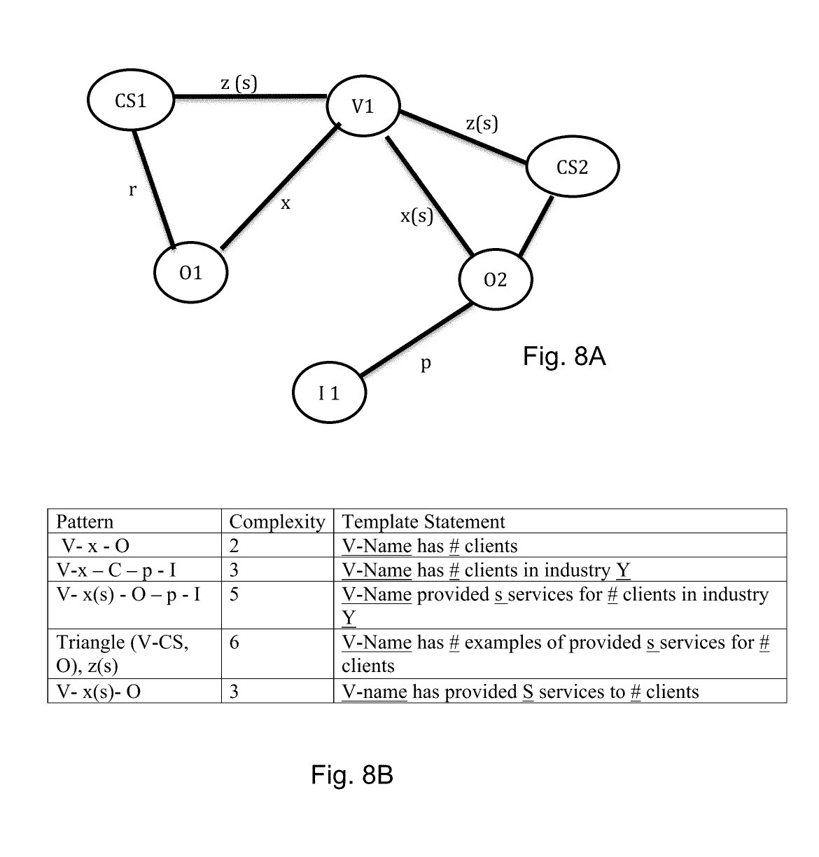

The present technology is implemented using a computer system and computer processing methods. FIG. 1 is an illustration of software agents and FIG. 8 is a block diagram of computing components provided in a system enabling searching and data processing.

FIG. 1 illustrates the interaction between client-computing devices 10, 11 and the server 12 over network link 15. The devices 10, 11 may communicate via a web browser 20 or smartphone APP 19, using software agents to receive input from the user, make HTTP requests and display data. The server 12 may be a reverse proxy server for an internal network, such that the client device 10 communicates with an Nginx web server 21, which relays the client's request to backend processes 22, associated server(s) and database(s) 14, 16 and 17. Within the server, software agents 25a-i perform functions such as, retrieve data, build and process data via service model(s), match requests and providers and calculate various score. Some software agents may operate within a notional web server to manage user accounts and access, serialize data for output, render webpages, and handle HTTP requests from the devices 10, 11.

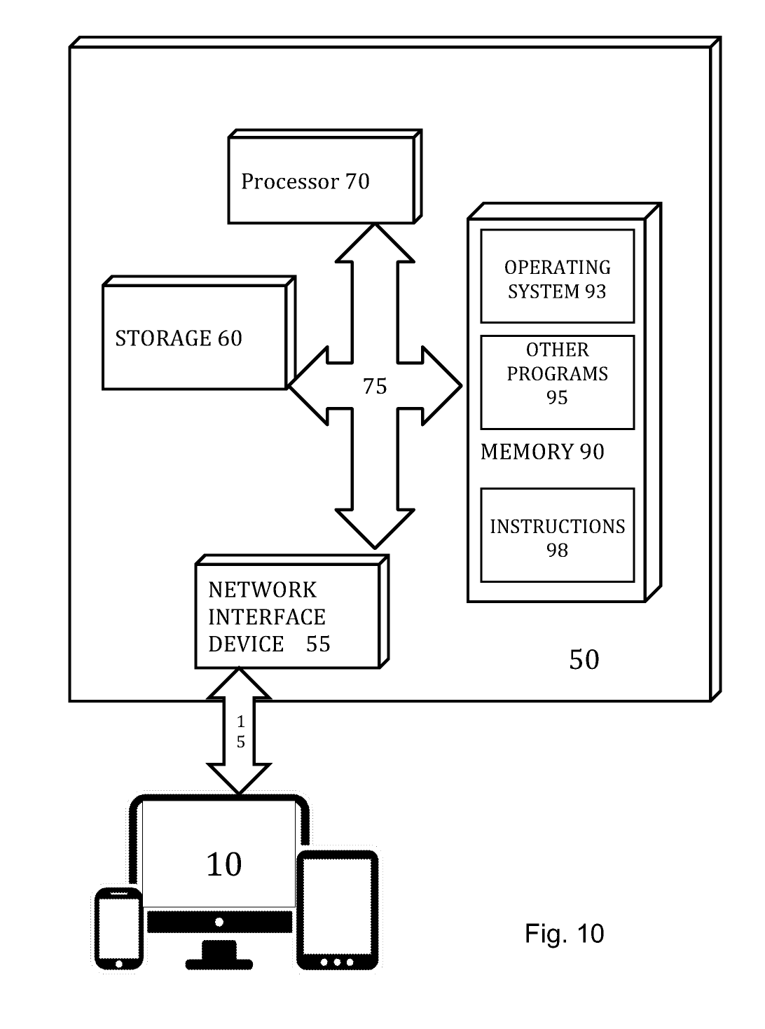

FIG. 10 is a block diagram of an exemplary computer system for creating the present system and performing methods described herein. The system 50 includes a bus 75 for connecting storage 60, non-volatile memory 90, one or more processors 70 and network interface device 55. The memory contains software for the operating system 93 and instructions 98 and other applications as may be needed. The network interface device communicates over the internet connection 15 with client devices 10, 11.

The one or more processors may read instructions from computer-readable memory 90 and execute the instructions 98 to provide the methods and agents described below. Examples of computer readable media are non-transitory and include disc-based media such as CD-ROMs and DVDs, magnetic media such as hard drives and other forms of magnetic disk storage, semiconductor based media such as flash media, random access memory, and read only memory.

Users may access the databases remotely using a desktop or laptop computer, smartphone, tablet, or other client computing device 10 connectable to the server 12 by mobile internet, fixed wireless internet, WiFi, wide area network, broadband, telephone connection, cable modem, fiber optic network or other known and future communication technology using conventional Internet protocols.

The web server will use the Serialization Agent to convert the raw data into a format requested by the browser. Some or all of the methods for operating the database may reside on the server device. The devices 10,11 may have software loaded for running within the client operating system, which software is programmed to implement some of the methods. The software may be downloaded from a server associate with the provider of the database or from a third-party server. Thus the implementation of the client device interface may take many forms known to those in the art. Alternatively the client device simply needs a web browser and the web server 12 may use the output data to create a formatted web page for display on the client device. The devices and server may communicate via HTTP requests.

The methods and database discussed herein may be provided on a variety of computer system and are not inherently related to a particular computer apparatus, particular programming language, or particular database structure. The system is capable of storing data remotely from a user, processing data and providing access to a user across a network. The server may be implemented on a stand-alone computer, mainframe, distributed network or over a cloud network.

### Database

An online social network comprises a database storing profiles of professional people and of organizations and also records social connections between people (e.g. colleagues, friends, communications, follow), between organizations (e.g. follow, client, vendor, partnership), and between people and organizations (e.g. follow, employment, “was educated at”). A graph is a suitable structure to implement such a database, whereby nodes store profiles for people/organizations and edges record the connections. The connections may be uni-directional (e.g. follow, like) or bi-directional (e.g. friendship, coworkers). The graph may be operated as a social network whereby users actively create connections and interact with other users.

Profiles of people or organizations may store professional data in a plurality of fields such as: skills, employment, education, and projects. Preferably certain professional data are stored separate from but connected to the profile. Thus the database may also store content as separate data objects, such as nodes in a graph that are connected by directed edges to indicate who owns or created the content. The content items may be case studies, awards, testimonials, articles, images, and videos, each of which pertain to a service from a service provider to a connected person or organizations. The content data object may store tags, labels, firmographic data about the client, and keywords that describe the related services offered or even a non-structured text document describing certain services. The content may

A database system may include or be derived from multiple databases, possibly including third party databases. Each database may store its own graph to capture certain relationship types and having at least some users in common such that a database system server can detect separate instances of a person on each graph, merge them, and analyze the mixed relationship modes between users across all graphs. Additional databases may be provided to store service models and search histories.

The database 17 is arranged to connect data objects of service providers to data objects of content item, other users and organization. Each data object contains attributes, tags, services, classifications, and/or text descriptions about the related person, organization or content item. Categories of content items include: awards; case studies; and testimonials.

### Services Model

The system may represent services and process data using a services model. The model may be a formal taxonomy, each node in the taxonomy representing a set of synonymous service n-grams (for example “patent drafting”, “file an invention,” “patenting”, “patentar,” “brevet” etc.). Each node may also be associated with a set of features, which features are indicative of the service but are not services themselves. These may represent skills, industry buzzwords, tools, and education that correlate well with the service for that node. For example, “Java” is not a service itself but correlates well with various services, including “web design.” The features may be stored as a feature vector indicating the strength or frequency of each feature with respect to that service.

In certain embodiments, a taxonomy is built using industry experts to map features found in profiles to each service. The model may include rules and weightings of features by field of the profile. For example, a skill feature may contribute progressively less when listed in older employment fields or features listed in endorsements could contribute more than job titles.

In another embodiment, a supervised classifier is built from expert or historical data to train the model. In this case, several thousand providers and content items are paired with their known related service are fed to a classifier in learning mode. Using one of many suitable classifier techniques, such as Nave Bayes, (forests of) decision trees, SVM, or neural nets the model learns mappings from profile features (e.g., n-grams, numerical values) to services.

In yet another embodiment, the model is built using unsupervised learning techniques. In this case, the model simultaneously learns what services exist, who provides them and what content features represents them. Without historical data, a topic model technique such as LDA, could be used, whereby the model learns which features (words/n-grams/phrases/skills/fields) commonly appear together. These commonalities are clusters of services and the users or content within those clusters are providers of or examples of those services. In the unsupervised case, there is a potential to learn non-intuitive commonalities and identify emerging services. However, the clusters do not necessarily define services as a human would.

The above models preferably incorporate a hierarchy from broad to specialist services. Thus providers of and search queries for general services are matched, whilst progressively more specialized service areas provide for more personalized matching.

Using any of above techniques, a processor builds a services model which is stored in a database or code. The processor then inputs profiles and content of service providers. The output is data indicating services that are relevant to the providers or content, preferably represented as a vector of services Sp and associated confidence scores Cp.

Preferably the services model is built offline and the output data stored. This output may be used to create indexes of service providers or of content. Alternatively the output are stored with each provider and content data object for subsequent traversal and extraction. These are updated periodically or as processing bandwidth becomes available.

Although separate models may be built for each type of data (e.g. service providers, queries, content, or social contacts), the services model may be conceptually understood as a single model.

FIG. 4 illustrates a Service Model Agent 25a for converting service provider data from a social network 17 to a Service Provider Index 14. The Model Agent may store representations of the services in models 16 such as a topic model or taxonomy.

### Search Query and Matching

The search query may be entered via a UI by a buyer-user, which query comprises search features taken from structured attributes or free-text. These features may be attributes of objects in the database, tags, keywords, or n-grams. The criteria may be selected from a set of predefined options. The predefined options may vary by service(s) requested, whereby a Search Engine selects, from a database, one or more sets of criteria options to display to the buyer. The free-text may be a document having a plurality of defined fields, such as background, goals, and service/project preferences.

The attributes of the buyer-user or their associated organizations (e.g. as employer) may be retrieved from the social network and appended to the search query, as buyer features. Thus the buyer may either explicitly search for service providers connected to companies of the buyer's size, location and industry or these attributes may be automatically added to the create the search query.

The Search Engine 25d may preprocess the search text to extract appropriate search parameters. The Engine may process the text using a services model to determine a vector of topic probabilities, latent variables, service classes, or key features. The Search Engine may compose the search query into two parts: a first part comprising search features for selecting organization objects (e.g. service provided, location, size) and a second part comprising search features for selecting objects connected to the organization objects (e.g. client industry, client location, client size, background).

Using a Topic Model, the search text may be converted to a distribution of service topics. An expert-system service model may include a mapping from features in the search document to the intended services.

The advantage of using free-text is that the service model can resolve the search query into subtle variations of services requested, by including consideration for other keywords used, which are not services themselves. The featured extracted by this pre-processing are searchable with an index of service providers maintained by the system.

The Search Engine identifies a set of service providers from the database that satisfy the search. The providers are preferably indexed by service to decrease the search time. Each service provider object has additional attributes such as size and location, from which the Search Engine scores and ranks the providers based on the quality of the match of the attributes to the search features. The output is a service provider relevance score, being a measure of similarity, distance or overlap of provider attributes and search features.

In the case where a Topic Model is used to estimate probabilities of similar topics, the search quality measure may use the f-divergence or KullbackLeibler divergence, which measures similarity between distributions. Alternatively the topics could be treated as a vector and a weighted distance calculated between topics of a search and of a provider object (e.g., weighted Euclidean or Minkowski distance). The Search Engine can use historical data of matches that were successfully accepted by users to vary the weights. Advantageously, this enables the matching algorithm to attenuate topics that are not decisive of a good match.

In the case where a vector representation of features (or of latent variables) is used, the measure can be calculated from the dot product of the service provider features and search features. Other functions to calculate similarity, distance, or overlap are known for each of the various modeling techniques that may be used to model the services.

In preferred embodiments, the search UI is arranged to receive a free-text query, which is processed using Natural Language Processing (NLP) to understand the context of the search. The Search Engine determines one or more classes, clusters or service nodes SR that match the request with confidence CR. The Search Engine may feed back, via the UI, indications of these services for user selection (e.g. using a drop-down menu). This allows the searcher to transform their request from a fuzzy request into a selection of services that actually exist within the service providers of the social network.

As discussed above, the service model may have a hierarchical structure in which case the feedback of potential matching services to the user may proceed from the most general level to the most specific, whereby the searcher progressively expresses interest in more specific services.

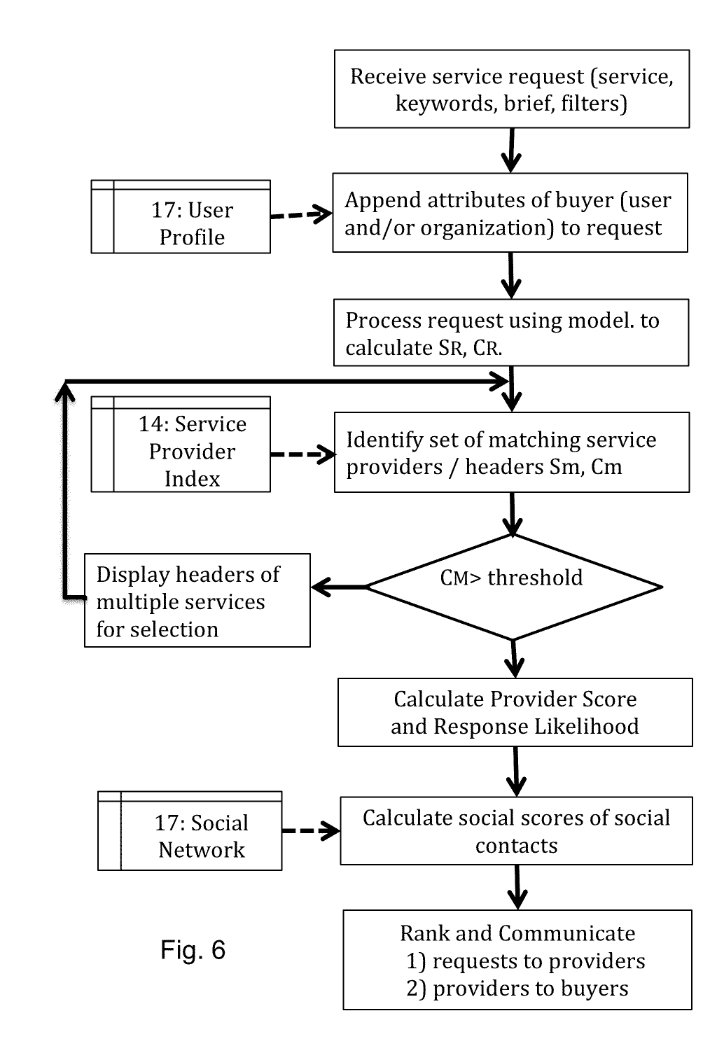

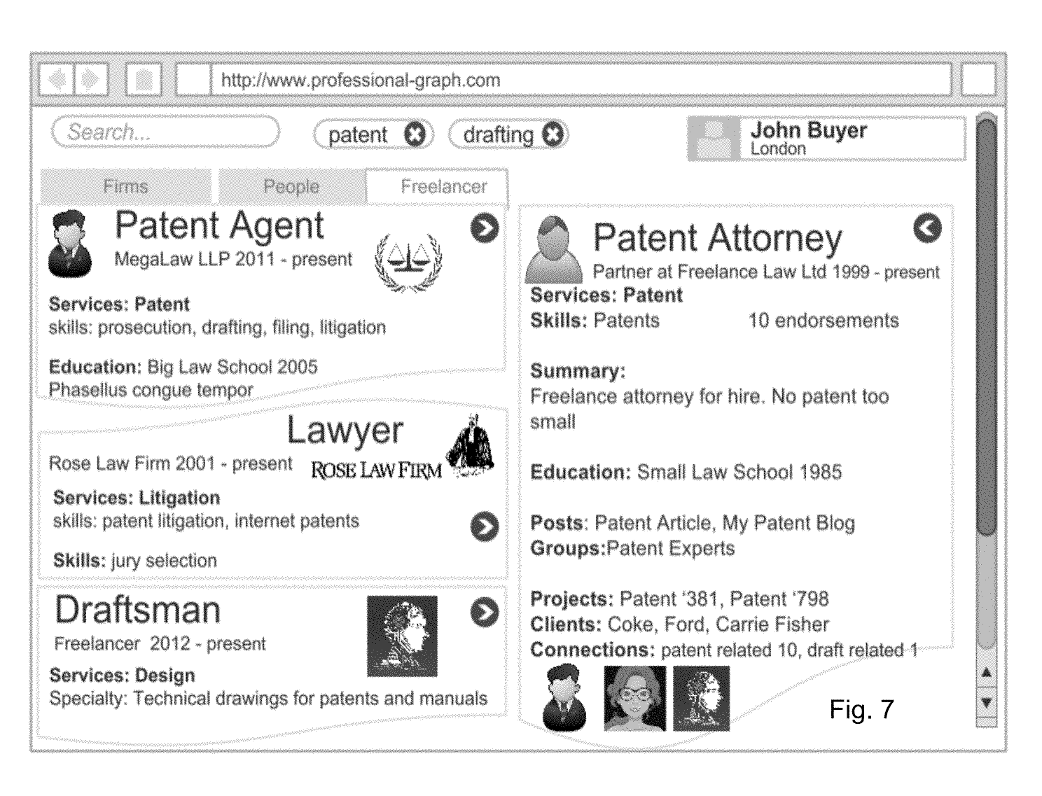

The workflow for matching a request is displayed in FIG. 6. The Search Engine receives, via the UI, search parameters comprising text features, filters and menu selections. The buyer's attributes are retrieved from the social network and if known, the requester's employer's attributes (e.g. locations, industry, size, name) are retrieved too. These attributes are appended to the user-entered search.

The search is processed using the Services Model. The Search Engine then identifies a set of results Sm of service providers from the service index or service headers from the model satisfying the search request with confidence CM. If the Services Model is hierarchical or the confidence about the matches CM is lower than a threshold, the Search Engine may display a plurality of service headers to the searcher to choose from. The Search Engine may repeat the search and re-display headers until a sufficient confidence CM is reached, until the lowest level of the hierarchy is reached or until fewer than a threshold number of service providers are within the set of results.

The Search Engine 25d calculates a search score for the providers in the set of results. The Search Engine returns a subset of the highest-ranking service providers as search results to the client-computing device of the buyer.

### Personalized Profile Display

For each provider selected by the Search Engine as search results, a dynamically created profile is created and displayed to the buyer to demonstrate relevance to the search and the buyer's attributes. The dynamically created, personalized profile comprises data elements that are most relevant to the search query. The data elements may be text, content items, social connections, or attributes of the providers.

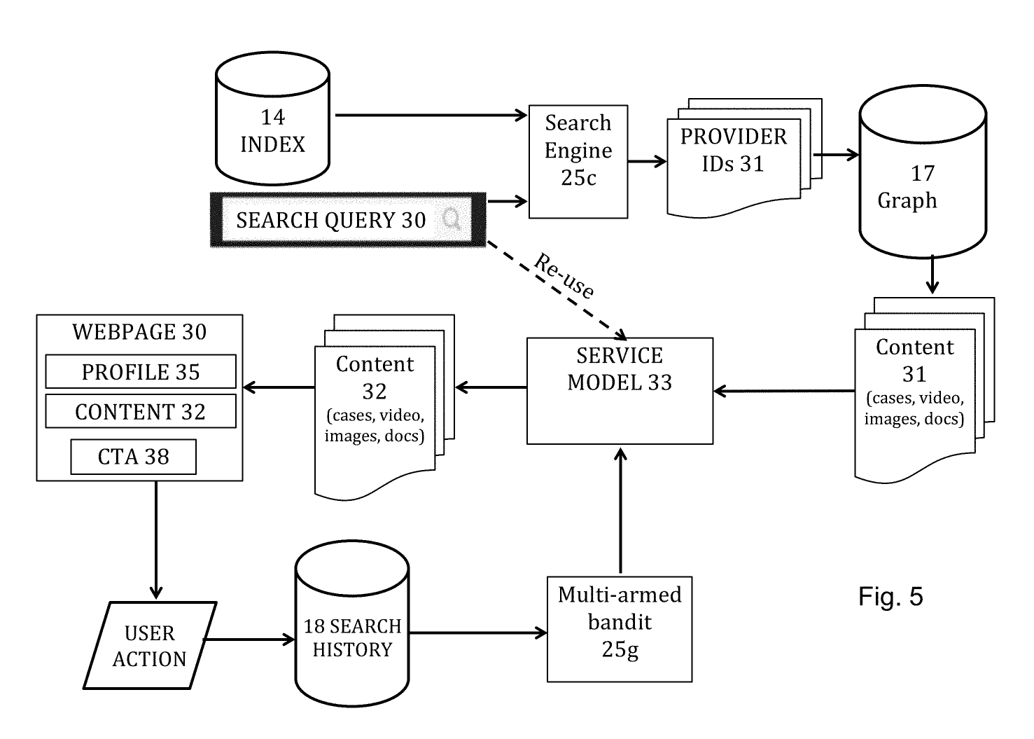

FIG. 5 displays a workflow to rank service providers and select object for certain providers from a search query 30. The server receives the search query from a buyer-user. The Search Engine 25d identifies, from an index 14, service providers that satisfy the search, to create a set of provider identifiers 31. The Profile Agent identifies from graph database 17, data objects (e.g. content items 31) connected with each provider object. Each object is processed by a services model 33, re-using the search query 30, to produce a subset of most relevant object (e.g. content items 32). The Profile Agent creates personalized profiles for each providers from their respective relevant object. The profile(s) may be communicated as a webpage to the client-computing device of the buyer.

The webpage contains user interface objects 38 for the buyer to interact or select providers or content items. These may be Call To Action buttons 38, which are received by the server as part of a feedback loop discussed below.

Some objects to display might be relevant even though they did not weigh significantly or at all in the initial search score. For example, awards and employees may be too lightly weighted to affect the rank of the providers but if the profile of one of the selected service providers is viewed, the most relevant people and awards are shown.

Thus preferred embodiments enable the system to produce a representation of the service provider that has less information than the standard profile but is also more impactful to the buyer. Repeat searches are not necessary to understand search results thus reducing the total processing required by a search engine. The system may store this representation for subsequent use, in order to reduce subsequent processing or conflicting representations being viewed.

In a preferred embodiment, the search engine first identifies organization objects representing service providers satisfying the search query (e.g. they provide the searched service and are located at the searched location). Then for a given service provider (such as a service provider selected by a user for closer inspection), the search engine identifies content data objects that are connected thereto. A similarity module calculates a relevance score for each of the selected content data objects based on the similarity between the buyer organization and one or more client organizations connected to the selected content data objects in the database. Thus similarity is only calculated for content that involves the searched services and from vendors that satisfy the search. The search engine then ranks the selected content data objects based on the relevance score in order to select the top ranking content for display. The number of content object to select for display depends on the client device and/or request to view more, and thus lower ranked, objects.

The buyer organization attributes may be 1) explicitly entered by the user, 2) determined by looking up the organization name in the database or 3) inferred from terms in the query. The similarity module 25f calculated similarity/relevance scores by comparing firmographic attributes of the organizations or text similarity of their profile descriptions. Similarity calculations are further described in U.S. Ser. No. 14/537,092 filed 10 Nov. 2014 and U.S. Ser. No. 14/690,325 filed 17 Apr. 2015.

Advantageously this embodiment reduces total computation time by retrieval only content data of the most relevant vendors and calculating relevance of content using simplified criteria. The database may be structures to optimize such queries by creating an index of content indexed by service and an index of content indexed by service provider ID. Additionally the data presented only provides evidence of provision of the searched service, arranged in order of the most similar clients for those services. This saves time for the user over alternative directories that simply show all content and clients of matching vendors, with no explanation of the relevance of content and clients.

### Profile Text

Text content may be used in the personalized profile. Search results from current search engines include the text that was written to appeal to all types of buyers, for all services. This necessitates long text descriptions to cover all aspects that might be of interest to a buyer. It also distracts the buyer from the far fewer descriptions that are relevant to the search.

Thus in certain embodiments a Text Agent 25i outputs one or more statements about a given service provider that are relevant to the search. The Agent may employ NLG to generate statements or employ a ranking technique to select statements from a pool of template statements.

For example, a paragraph of text may comprise a general purpose sentence and one or more template sentences that are personalized by the Agent, such as:

“Company X is a global PR firm founded in 1922. They have extensive experience in press releases as evidenced by their 22 cases. They have worked with 33 Forestry companies over the last 10 years. They recently won an award for their mining client in press releases services.”

Underlined passages above are auto-completed by the Text Agent based on data in the database(S) that are relevant to the search parameters. The Text Agent traverses the graph to determine the number of case study objects (22) that are connected with the service provider (company X) and that match the searched service (Press Release). This is repeated for other attributes related to the search (such as industry, size, or location parameters), other objects associated with the service provider (such as awards, case studies, and testimonials) and attributes of the buyer (industry, size).

The Text Agent may also select relative descriptors and n-grams (“big” vs. “small”, “specialized in” vs. “full service provider of”) in sentences by quantifying or qualifying the data relative to threshold amounts or to other service providers and using a look-up table of n-grams for given a given quantity of connected objects.

In certain embodiments, variations of similar template sentences are auto-generated and scored by the Text Agent with respect to the search parameters and/or buyer attributes. The highest scoring sentence is displayed.

The Text Agent also computes an impact score, to determine which sentence is likely to have the most impact on the buyer. The Agent may process each candidate sentence using the services model. One algorithm of the model would be to weight by attribute type included in each sentence. This could be the same weighting as the matching algorithm used in the services model. Consider the impact score of the following sentence for a search for accounting services in Boston by a NY Pharma buyer:

“Company1 has an office in Boston, which serves 7 New York clients and 4 pharma clients and has received 6 awards for accounting”

This sentence fragments are scored as:

| | |
|---|---|
| 4 clients × 10 = 40 pts; | / same_industry_weight = 10 |
| 7 clients × 3 = 21; | / same_location_weight = 3 |
| 1 office × 5 = 5; | / same_city_weight = 5 |
| 6 awards × 1 =6; | / award_weight= 6 |

Total impact score = 72.

Alternatively the Agent may parse the statements into fragments and discard fragments with low impact scores. In the above example, contributions from office location and awards have low impact and may be removed. The profile text chosen may thus be reduced to simply “Company1 has 4 pharma and 7 New York clients” or qualitatively “Company 1 has many New York Clients and some Pharma Clients.”

Preferably each template statement corresponds to a graph pattern, where the impact score increases with the complexity of the pattern. Complexity is a measure of the number of nodes, edges and attributes thereof that define the pattern. The Text Agent traverses the graph, following each prescribed pattern, and counts the number of unique patterns for a given service provider. FIG. 8A is a graph of objects connected to node V1, for which template statements are being evaluated. The graph comprises organization nodes (O1, O2), case study nodes (CS1, CS2). Industry node (I 1) and edges (z, x, p, r). FIG. 8B is a table used to define the graph pattern, its complexity and the corresponding template statement. The first pattern listed defines a graph traversal from the service provider node, V1, to an organization node via an edge of type x (which may indicate V provides service to O). In FIG. 8A, two such patterns exist (to node O2 and O1). The path complexity is 2 because there are two path requirements (edge of type x and node of type ‘organization’). To complete the template statement, the Text Agent retrieves the ‘name’ attribute from node V and counts the number of unique paths (2). These values are inserted into the templated at the appropriate underlined sections of the statement.

Complexity increases as further requirements are added, such as a) industry value (as an attribute of the organization or industry node connected to the organization node), b) service provided (s) stored as an attribute of the edge, or c) that three nodes of specified type are mutually connected as a triangle {V1, O1, CS1} and {V1, O2, CS2}.

The Text Agent determines which of the patterns are specified by the search parameters to create a set of candidate statements. For example, a search with complete search parameters would include all statements as candidates. For a given provider, the impact score of each candidate statement may be the complexity of the pattern multiplied by the count of the pattern found for that provider. The highest scoring statements are selected for display, although, more than one candidate statement may be selected.

The Agent analyzes the overlap of candidate statements and removes or combines highly correlated statements. Thus while two similar sentences may be true and impactful to the buyer on their own, the marginal impact of the second statement is negligible. The Agent may choose the single most impactful statement of plural statements that have a threshold amount of pattern overlap (e.g. they specify several of the same edge types, node types and attribute values).

In an alternate embodiment, the Text Agent scores pre-written profile statements using the search query parameters. The pre-written statements contain features (words, numbers, n-grams) which are analyzed and compared to the search query using document similarity techniques. For example, a topic model, vector model, state vector machine, matrix factorization or named-entity recognition may be used to compare the statement features and the query. Pre-processing steps such as removing stop-words, TF-IDF, stemming and semantic similarity mapping are useful to convert the features of the profile sentences and query into comparable forms.

For example, the profile sentence “we specialize in helping pharma companies in the D.C. area with their marketing needs, such as improving their website's CTR” is converted by an Natural Language Understanding model to the feature vector (special, pharma, Washington D.C., marketing, improv., website, click through rate). Similarly the search query with the search phrase “we are looking for experts in making click-thru-rate improvements to our site” converts to the vector (expert, click through rate, improve, site) which then has appended to it the search filter parameters [location=Washington, D.C., size=medium, service=marketing and advertising, subservice=digital marketing, industry=pharmaceuticals], which parameters may also be preprocessed to feature equivalents. For example pharmaceuticals becomes pharma. Certain features of the profile sentences may be extracted as recognized standardized parameters, such as location=+38.8951/−77.0364, industry=pharma, service=marketing and advertising, subservice=digital marketing.

These two vectors and parameters are compared using the above techniques to produce a score for the profile sentence. For example, the score may be the dot product of the search query vector and the profile sentence vector. The Text Agent then selects the highest scoring sentences for the personalized service provider profile.

### Content Ordering

The profiles may be further personalized by varying the order of content to be displayed. Classes of content as well as specific content within a given class may be scored by the Profile Agent using the search query and buyer attributes. For example, classes of content items relevant to a search parameter that was specified or highly weighted are shown before classes of content items that were not specified. The Agent may maintain an ordered or weighted set of classes of content per search parameter. Thus a particular class of content is displayed first for certain search locations or certain service classes. The Agent may score or rank classes then multiply or apply them to selected items in each class.

### Attribute Display

The profile may be personalized by selecting attributes of a service provider for display that are most relevant to the search query. The Data Retrieval Agent 25h retrieves attributes (size, locations, services, industries served, etc) stored with a given service provider data object. The Profile Agent processes the attributes to determine which attributes are most relevant to the search query. The most relevant attributes are used in the dynamically created profile representation of that provider.

For example, an organization may have many offices, each of a different size, providing different services, to different industries. Rather than display all offices in alphabetical order as some current search engines do, the present system displays the closest office(s) that provide the queried service to the queried industry. A failing of current search engines is that they provide search results that match the query simply by looking for the existence of the searched attributes. Thus a vendor may be displayed which has a matching office, a matching service (from a different office), and serving an industry (but only from a third office). This should not be a relevant vendor. The present system preferably segments and structures attributes in the database such that correspondence between values of different attributes types are determinable, e.g. Office X provides service A, B, C; Industry Z is served from offices X, Y.

### Social Display

The profile may be personalized by selecting data objects of immediate social contacts, such as users and organizations connected to service providers in the social network. The selection is based on the professional relevance of the users or organizations to the search. The Profile Agent processes the data objects of connected users and organizations using the services model and search query to rank the users and organizations. The most professional ones are selected and used in the dynamically created profile of the service provider. The Agent may compare relevance scores to a threshold value or relative to the other user scores.

One factor for scoring professional relevance may be the degree to which immediate (i.e. first hop) social contacts of a service provider are qualified to recommend the provider for the service request. The Profile Agent evaluates the profile data of the social contacts relative to the search query or relative to services offered by the service provider. This is not a measure of likelihood that the provider is connected to the buyer but rather a measure of the professional relevance of the service provider's own immediate social network towards the services provided or the services requested. Thus the existence of relevant social contacts is an indication of the service provider's relevance rather than identification of people for the requester to contact in order to receive a reference.

A second factor is the inferred professional insight that the social contact is likely to have about the service provider. The Profile Agent infers this by detecting a professional overlap between a social contact and provider with respect to an employer or a past project. The graph may be structured in various ways to record employment and mutual association with past projects, with corresponding various ways to structure the overlap query. For example, an employment graph may store people and organizations as nodes with edges between people and organizations recording employment, wherein the edge object stores values for the job title and period of employment. A professional overlap may also exist from working on a past project together, i.e. not necessarily as coworkers. An edge between user nodes may record a mutual project, or user nodes may both be connected to a common project node.

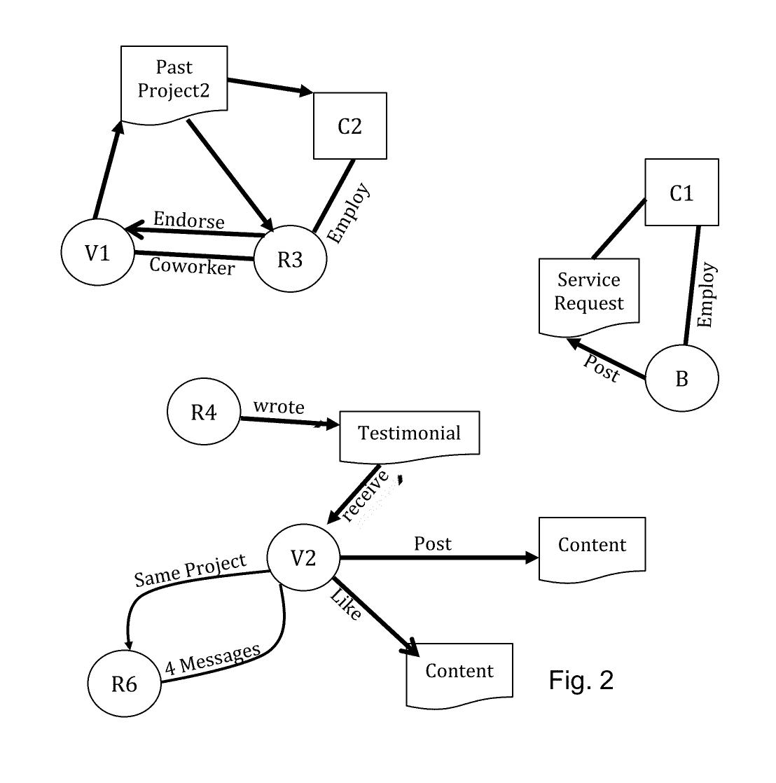

FIG. 2 illustrates a portion of a social network including the buyer B, companies C1 C2, social contacts R3, R4, R6 (referees), and two identified service providers F1, F2. For ease of understanding, squares represent companies C, circles represent users (freelancers F and referees R), document shapes represents service request, past projects, and posted content. Lines represent bi-directional connections and arrows represent unidirectional connections.

Which Provider has the more relevant social score? F1, R3, and C2 are all connected to Past Project2, which project is determined to be relevant to the services offered or services requested. C2 has firmographic attributes similar to C1, the employer of the Buyer B (buyer organization). R3 has endorsed and previously worked with F1. These weigh in favor of F1.

Provider F2 is connected to three referees with varying professional relevance, social activity and connection modes to F2. F2 has also posted content, which content is determined to be relevant to the services offered or services requested. These weigh in favor of F2.

Using the above factors, for each social contact, a relevance score is calculated. The Profile Agent selects the most relevant social contacts for inclusion in the provider profile.

### Differentiation

The Profile Agent may also select elements to personalize based on what differentiates the service providers. This may apply to text statements, content items, clients and attributes of service providers. For example, if many providers in the search results have won the same award, then this award's relevance score is attenuated or the item is simply not selected for display, even though it is relevant to the search. Text statements that describe a provider's relevance to the search or buyer are further selected by those that differentiate a vendor.

Example search “Accounting service in SF for small, NY, pharma buyer”

V1 has 5 NY clients, 8 awards for accounting, 2 pharm clients.

V2 has 4 NY clients, 2 awards for accounting, 7 pharma clients.

These text are re-written to highlight differentiators:

“V1 has 8 awards for accounting”

“V2 has 7 pharma clients.”

### Feedback Loop

The present system may employ a Feedback Agent 25g to improve the service model 16 based on user responses to the dynamically created profiles. The web server 21 via the User Interface to the user of the client device 10,11 may detect user actions or selections of certain parts of the web page that correspond to content items or to a service provider itself. The user actions may be clicking on an items, dwelling on or about an item, or scrolling within a group of items. Certain web technologies such as Java and HTML provide event UI feedback functions, such as OnClick, OnMouseMove, OnScroll, and touch screen gestures of tap, pinch, zoom, swipe.

The Feedback Agent detects these user actions and determines the associated content item or service provider. From the user's perspective, these actions lead to the website displaying content items more fully, playing video, enlarging images and text, and saving or rejecting service providers. The Feedback Agent interprets these actions as indicators that a content item or provider was relevant to the search query (or not relevant in the case of rejection). The Feedback Agent in conjunction with the Service Modeling Agent 25a update the model to better predict relevance of content items during a subsequent search. The feedback comprises the 1) content item or service provider; 2) the search query; and 3) the user action.

The effect is a correlation between items/providers and the search parameters with a weight proportional to the user action taken, e.g. weakly positive, positive, or negative. The content items, providers and search are preferably tagged, classified, or otherwise processed such that a generalized correlation is feedback and thus generally applicable in subsequent searches.

The Feedback Agent may simply mark the content item selected as relevant to the search parameters but preferably uses a machine-learning algorithm to train the model from this feedback.

The mechanism may use techniques from probability theory and reinforcement learning, such as the multi-armed bandit approach and Markov Decision Process. These approaches determine which content items or providers of a larger set will maximize subsequent user selections if they are displayed. In the multi-bandit approach, every search represents a gambling opportunity over several machines (content items to display) with a tradeoff between total expected payoff (positive user action) and exploration of payoff of other machines (other content items).

The feedback is shown in FIG. 5. A user action with respect to webpage 30, profile 35, content 32, or call-to-action (CTA) 38 leads to detecting and recording in search history database 18. A batch of search queries and user actions are used by multi-armed bandit 25g to update the model 33 to determine what content item or class of content items is expected to have the highest reward next time.

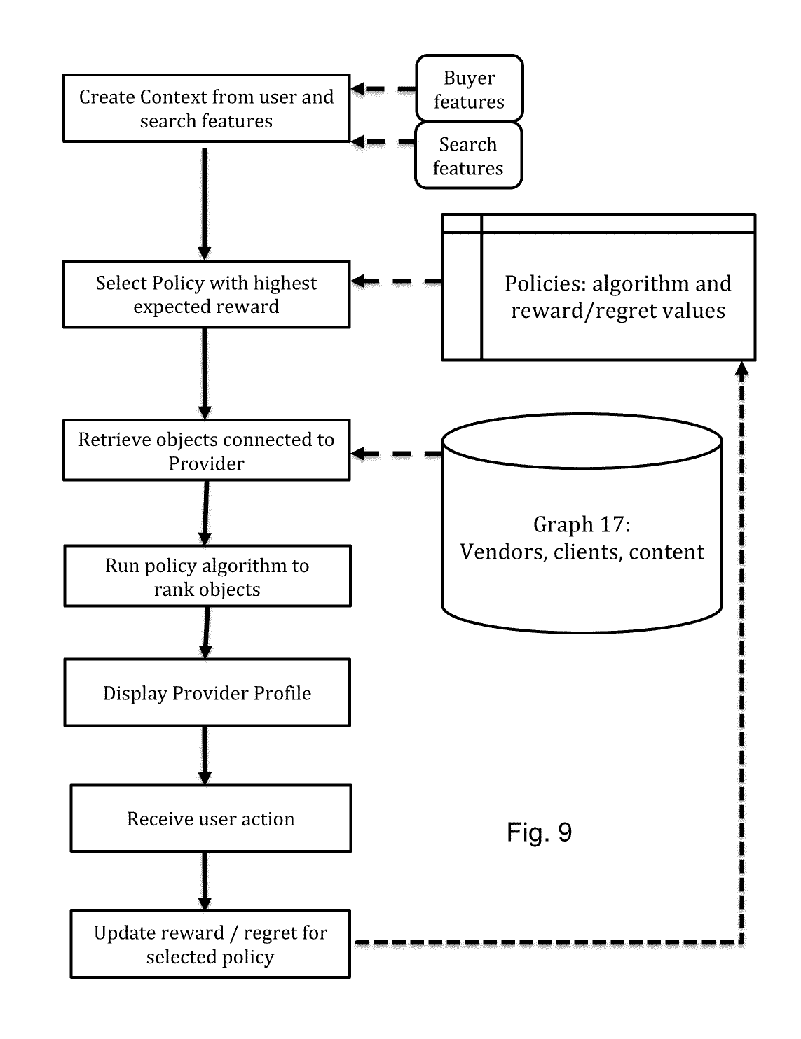

FIG. 9 provides a flowchart for a contextual multi armed bandit (CMAB). In this technique, content items are selected by running a policy, which policy is selected by the CMAB module depending on the present context. The context is a set of features created from the search query and the user features.

There is a plurality of policies, each of which comprise different instructions for object selection, function types, coefficient weightings, and logical operation. A policy may select more than one object for an interaction and the policy may vary the positioning of objects. These policies may be programmed using an expert system, sets of assumptions, or candidate function types. For example, one policy may exist for each of a) ranking objects based on graph distance to the Provider node b) ranking objects based on sums of Provider weighted attributes c) rank objects using a diminishing returns algorithm or d) sets of rules (e.g. “if context=X then rank object using F(attributes), else if context=X′ then . . . ”). Initially the reward for each policy is unknown but may be initialized to some non-zero value.

For each search query iteration, the CMAB module selects the policy with the highest current expected reward. The CMAB module runs the selected policy and observes any user-action. The CMAB module updates the reward/regret statistics for the selected policy. Each time a selected policy results in a certain user-action, the CMAB increases the reward statistic and when it does not, the CMAB increases the regret statistic. During the initial explore phase, policies have a high reward variance, meaning that there is a potential for a high reward. As the module learns, each policy's variance reduces and their reward converges to a stable value. The statistics may change in time, with new users and new objects added to the database.

In the graph, vendors are connected to a limited set of objects with little overlap. Therefore, for a given Provider node, the CMAB module selects only objects connected thereto and the policy operates only on those objects. As there are few overlapping objects, the policies and the lessons learned are generalized to apply to all objects of a certain type, rather than individual content items. This also enables new content items to be added without re-optimizing for that item.

The module may employ a classifier/clustering technique to learn classes/clusters of objects, for which the objects may be selected by a policy. Thus the module may group objects with certain attributes into a cluster and the optimal policy may learn to select objects from within that cluster, and rank those objects according to function.

### User Control

The system may further comprise control means operated by a user associated with the service provider to determine certain items of the profile data to be displayed. For example, a UI may be used to input rules to guide whether to focus on or hide certain content items, even though their social network contains many more elements that could be displayed. For example, some elements may be deemed: anonymous to outside users; part of the provider's legacy, rather than their future; or of strategic priority to the provider.

This control setting may flag content as priority, hidden, default, dynamic, or conditional. Priority elements should be displayed whenever possible. Default items are displayed when buyer personalization is not possible. Dynamic items can be selected by the Profile Agent. Hidden items are never displayed, although they may contribute to the overall matching. Conditional items are only selected if the inclusion/exclusion conditions of certain buyer attributes and search parameters are met. Example rules, include a) display client name if buyer industry is Beverage, b) Display CEO name if searcher job title >director, and c) Display Social Media projects if search is for social media marketing.

### Search Optimization

To reduce real-time search retrieval and ranking, in certain embodiments, the system creates and maintains multiple inverse indices, each index corresponding to a one-dimensional or two-dimensional search parameters. For example, a 1-dimensional index for location provides a look-up by city name to return an ordered set of service providers that have the location attribute equal to that name. Each of the results in the set may comprise the service providers identifier and a score with respect to the lookup parameter. The score may be pre-calculated, as discussed above. For example, the score for a given service provider may be a) the proximity of a service provider from the city indexed or b) the number of their client having the industry tag indexed.

Similarly a 2-dimensional index may provide a look-up for a pair of search parameters, such as [location, industry], [size, location], and [size, service]. Given the high number of 2-dimensional indices possible, the system preferably maintains these indices for the most common and impactful pairs of search parameters. Advantageously the system may use the graph database to select members that of the 2-dimensional indices

The search engine may determine the intersection of sets of service providers from two or more indices. The search engine selects indices for search parameters that combine to make up as much of the search query as possible. For example, if the search query comprises five parameters, the search engine selects two 2-Dimensional and one 1-Dimensional indices to cover all the parameters uniquely.

### Personalization Persistence

A subsequent issue arises when profiles are personalized with respect to a search is how to handle the user revisiting the profile at a later date. Using cookies or creating user accounts is a known way to ensure that a given user can see stored lists of data objects. However, existing system do not store the search query associated with a stored object nor remember how a profile should be personalized. This is another reason why profiles are typically static. The issue is further complicated as users typically run many searches to explore the database from different angles. Therefore existing systems cannot know how to vary a profile when revisited at a later time by the user.

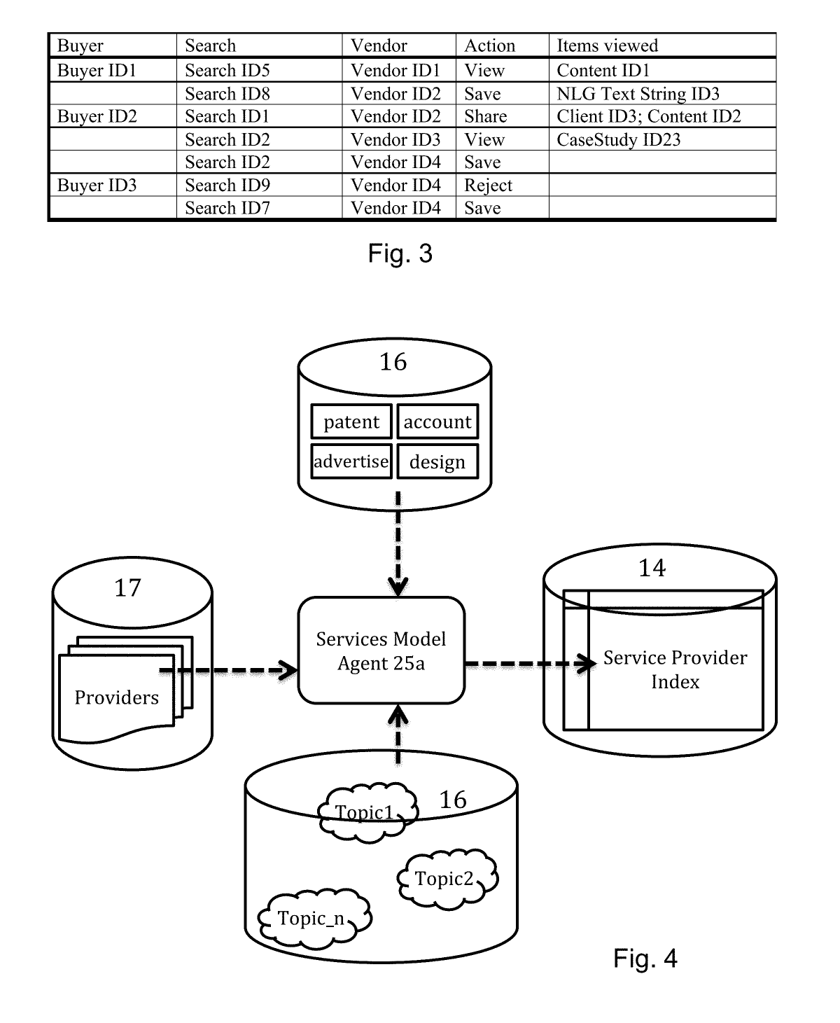

Thus in preferred embodiments, the present system stores the search query that was used when a user selects a service provider from a set of search results. The system stores the search query and the selected service provider in search history database 18, associating both with a user account. As exemplified in FIG. 3, a buyer data object may have a table comprising search queries, service providers and user action. Alternatively, as a graph, the buyer node is connected to service provider node via a edge, the edge recording the search query and the nature of the selection, e.g. shortlisted, follow, like.

The saved search query enables the user to revisit the personalized provider profile without storing the entire personalized profile. Additionally the personalized profile is continuously updated as new content is added to the database.

The personalized profile may also be shared with another user. In this use case, the first user saves one or more service providers, which are saved together with the search query. The first user then selects, via a UI, a second user and the saved service providers. The system notifies the second user of the opportunity to view the service providers and when so requested, dynamically creates and displays the provider profiles using respective saved search queries of the first user. This method improves the ability of the computer to communicate the rationale for selecting a provider and reduces the need for processing additional search queries from the second user.

### Display

The system receives queries and communicates results to users via a user interface on the user's computing device. The system prepares web content from the representations of service providers. A serialization agent serializes the web content in a format readable by the user's web browser and communicates said web content, over a network, to a client computing device.

Display of a provider or content items means that data elements identifying a provider are retrieved from a data object in the database, serialized and communicated to client computing device 10, 11 for consumption by the user. Display of a content item may be made by displaying the text from the document or a multi-media file (e.g. JPEG, MPEG, TIFF) for non-text samples of project.

The above description provides example methods and structures to achieve the invention and is not intended to limit the claims below. In most cases the various elements and embodiments may be combined or altered with equivalents to provide a recommendation method and system within the scope of the invention. It is contemplated that any part of any aspect or embodiment discussed in this specification can be implemented or combined with any part of any other aspect or embodiment discussed in this specification. Unless specified otherwise, the use of “OR” and “I” (the slash mark) between alternatives is to be understood in the inclusive sense, whereby either alternative and both alternatives are contemplated or claimed.

Reference in the above description to databases are not intended to be limiting to a particular structure or number of databases. The databases comprising documents, projects, business relationships or social relationships may be implemented as a single database, separate databases, or a plurality of databases distributed across a network. The databases may be referenced separated above for clarity, referring to the type of data contained therein, even though it may be part of another database. One or more of the databases and agents may be managed by a third party in which case the overall system and methods or manipulating data are intended to include these third party databases and agents.

For the sake of convenience, the example embodiments above are described as various interconnected functional agents. This is not necessary, however, and these functional agents may equivalently be aggregated into a single logic device, program or operation. In any event, the functional agents can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A computer-implemented method of personalizing webpages, the method comprising:
a server receiving, from a client device, a search query regarding vendor objects;
identifying, from a database, vendor objects representing service providers satisfying the search query;
for a given vendor object;
identifying, from the database, content objects connected in the database to that vendor object, representing a past provision of a service matching the search query;
calculating a relevance score for each of the selected content objects based on the search query to rank the content objects;
dynamically creating a webpage from the given vendor object and some of their ranked content objects; and
communicating the webpage to the client device.

2. The method of claim 1, further comprising comparing the data objects of service providers to the search query to select a set of service providers for which digital representations are created and communicated.

3. The method of claim 1, further comprising calculating the relevance score for the selected content object based on the similarity between the buyer organization submitting the search query and client organizations connected to the selected content objects in the database.

4. The method of claim 1, further comprising the server detecting from the client devices a user-selection with regard to one or more of the service providers or one or more content and
in response to said user-selection, automatically adjusting the service model for subsequent predictions of relevance of content items.

5. The method of claim 1, further comprising creating and communicating to the client device a web page comprising one or more of the digital representations.

6. The method of claim 1, further comprising the server receiving from a user associated with one of the service providers, one or more rules about communicating content items of that service provider.

7. The method of claim 1, further comprising the server receiving from the client devices a user-request to save one or more of the service providers in association with a user account, and in response to said response, saving the service provider and the search query in association with a user account.

8. The method of claim 1, wherein content items are one or more of: case studies, text documents, testimonials, sample work, and awards.

9. The method of claim 1, wherein content item data objects describe a service previously provided by a service provider connected to the content item data objects in a social network.

10. The method of claim 1, further comprising creating statements from aggregated attributes of the connected content objects and including said statements in the webpage.

11. The method of claim 1, wherein the content objects are further ranked using a multi-armed bandit algorithm, which algorithm is updated based on user action with respect to the webpage for that vendor.
